(19) United States
(12) Patent Application Publication
(10) Pub. No.: US 2016/0295643 A1
(43) Pub. Date: Oct. 6, 2016

(54) Replacement Modules For Cooktops

(71) Applicant: Anthony T. Duong, Saratoga, CA (US)

(72) Inventor: Anthony T. Duong, Saratoga, CA (US)

(21) Appl. No.: 14/678,401

(22) Filed: Apr. 3, 2015

(51) Int. Cl. H05B 3/76; H05B 3/74

(52) U.S. Cl. CPC H05B 3/76; H05B 3/74

(57) ABSTRACT

An apparatus relates generally to a cooktop. In such an apparatus, an induction heating module has an electrical connector. The electrical connector is configured for coupling to a socket for an electrical resistance heating coil of a conduction heating cooktop for receiving an electrical input. The induction heating module is configured for interchange with the electrical resistance heating coil associated with the conductive heating cooktop.

### FIELD OF THE INVENTION

The following description relates to cooktops. More particularly, the following description relates to replacement modules for cooktops.

### BACKGROUND

Conventional electrical-resistance conduction heating cooktops are less energy efficient than induction and radiant heating cooktops. Unfortunately, in the past, an entire conduction heating cooktop, which often is in working condition, may have to be replaced with an induction or a radiant heating cooktop to obtain the benefits of such induction or radiant heating cooktop.

### SUMMARY

An apparatus relates generally to a cooktop. In such an apparatus, an induction heating module has an electrical connector. The electrical connector is configured for coupling to a socket for an electrical resistance heating coil of a conduction heating cooktop for receiving an electrical input. The induction heating module is configured for interchange with the electrical resistance heating coil associated with the conductive heating cooktop.

An apparatus relates generally to a cooktop. In such an apparatus, a radiant heating module has an electrical connector. The electrical connector is configured for coupling to a socket for an electrical resistance heating coil of a conductive heating cooktop for receiving an electrical input. The radiant heating module is configured for interchange with the electrical resistance heating coil associated with the conductive heating cooktop.

A method relates generally to a cooktop. In such a method, an electrical resistance heating coil is unplugged from a socket of a conductive heating cooktop. The electrical resistance heating coil is replaced with a replacement module. The replacement module is either an induction heating module or a radiant heating module. Each of the induction heating module and the radiant heating module has an electrical connector for engagement with the socket. The replacing includes plugging-in the electrical connector of either the induction heating module or the radiant heating module into the socket.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIG. 1 is a top view depicting an exemplary conventional electric conduction heating stovetop.

FIG. 2 is a top view depicting an exemplary conventional electric burner.

FIG. 3 is a top view depicting an exemplary radiant heating module with a top plate, namely a cooktop platform, thereof removed.

FIG. 4 is a bottom projected view depicting an exemplary radiant heating module.

FIG. 5 is a top view depicting an exemplary conventional electric conduction heating stovetop with a radiant heating module replacing one of the electric burners.

FIG. 6 is a cross-sectional side view depicting an exemplary radiant heating module.

FIG. 7 is a cross-sectional side view depicting another exemplary radiant heating module.

FIG. 8 is a cross-sectional side view depicting yet another exemplary radiant heating module.

FIG. 9 is a top view depicting an exemplary conventional electric conduction heating stovetop though with a radiant heating module of FIG. 8 replacing one of the electric burners.

FIG. 10 is a top view depicting an exemplary conventional electric conduction heating stovetop though with radiant heating modules replacing all the electric burners of such conventional electric conduction heating stovetop.

FIG. 11 is a top view depicting an exemplary induction heating module with a top plate, namely a cooktop platform, thereof removed.

FIG. 12 is a bottom projected view depicting an exemplary induction heating module.

FIG. 13 is a flow diagram depicting an exemplary replacement process.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items; however, in alternative examples the items may be different.

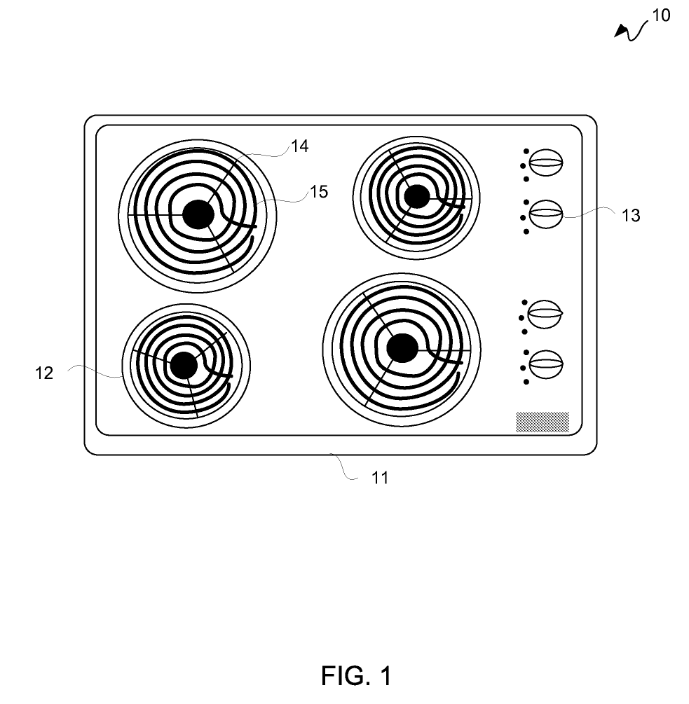

FIG. 1 is a top view depicting an exemplary conventional electric conduction heating stovetop 10. Stovetop 10, which may be part of a range or may be a separate cooktop, may have an upper platform surface 11 with spill or drip wells or bowls 12 that fit into corresponding recesses in such upper platform surface. A drip bowl 12 may have a hole or holes for feeding leads of an electrical resistance heating coil, collectively an electric burner 14, into a socket of a conduction heating stovetop for receiving an AC electrical input.

Conventional electrical-resistance conduction heating coils 15 respectively of electric burners 14 are not as energy efficient as induction or radiant burners. Heating level of electric burners 14 may be controlled, such as via corresponding control knobs 13 or other control interface. As stovetop 10 is well known, it is not described in unnecessary detail herein for purposes of clarity and not limitation.

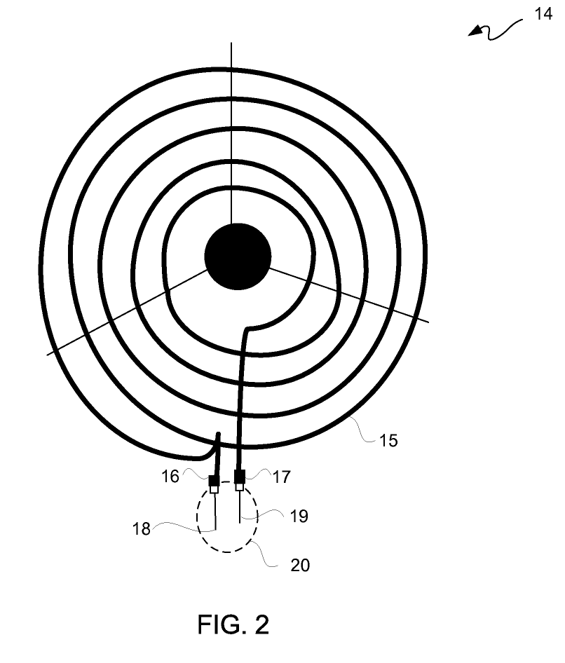

FIG. 2 is a top view depicting an exemplary conventional electric burner 14. Electric burner 14 conventionally is formed of a spiraled electrical resistance heating coil 15. Heating coil 15 may have an electrical source and return leads 16 and 17 to which heating coil 15 is attached. Leads 16 and 17 may be respectively attached to electric prongs 18 and 19 of an electrical connector 20.

As describe below in additional detail, electric burner 14 may be replaced with an induction heating module or a radiant heating module having an electrical connector 20.

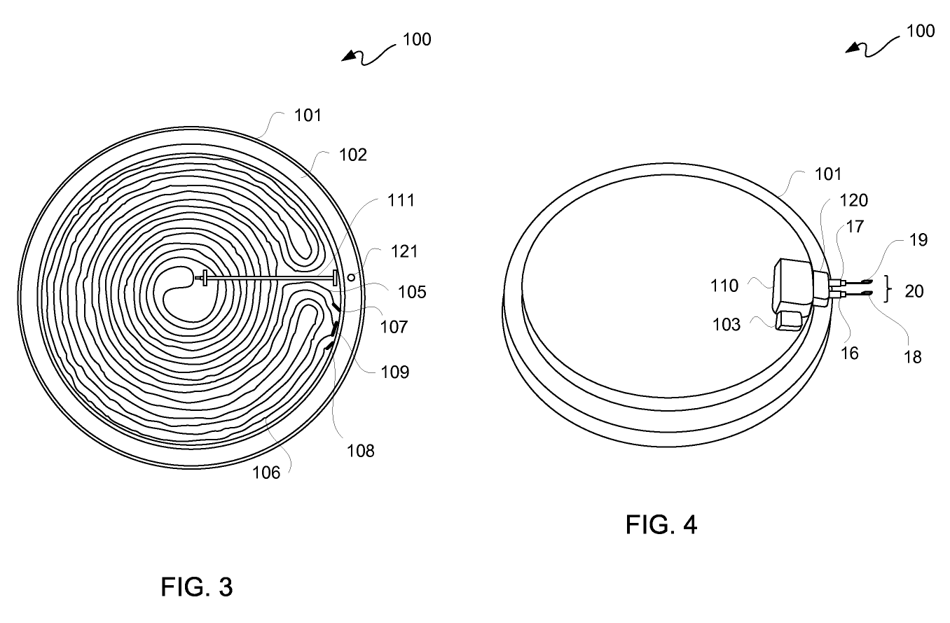

FIG. 3 is a top view depicting an exemplary radiant heating module 100 with a top plate, namely a cooktop platform, thereof removed, and FIG. 4 is a bottom projected view depicting radiant heating module 100. Radiant heating module 100 is further described with simultaneous reference to FIGS. 3 and 4.

Radiant heating module 100 includes a housing 101, an insert 102, a thermostat 103, an inner heating element loop 105, an outer heating element loop 106, a source terminal 107, a source terminal 108, a common return terminal 109, an optional pot/pan sensor 121, an electrical interface block 110, a temperature sensor 111, a controller 120, and an electrical connector 20. For example, housing 101 may be a metal housing, and insert 102 may be a ceramic insert. Ceramic insert 102, as well as housing 101, may have a bowl shape to provide a “ceramic bowl 102” located in housing 101.

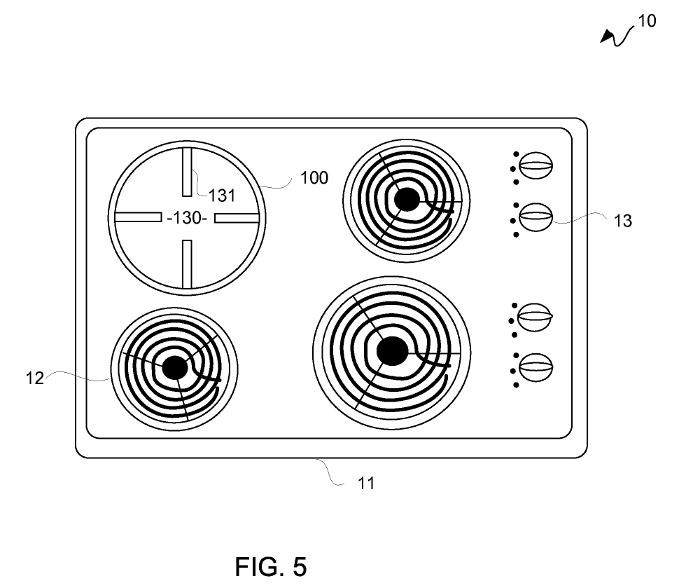

One or more radiant heating coils, such as inner heating element loop 105 and outer heating element loop 106 for example, may be located in ceramic bowl 102. Terminals 107, 108 and 109 may be coupled to conversion block 110 through housing 101 and insert 102. Additionally, thermostat 103 may be coupled to housing 101 and to electrical interface block 110, and a temperature sensor 111, located in ceramic bowl 102, may be coupled to thermostat 103 through housing 101 and ceramic bowl 102. Sensor 121 may be in electrical communication with conversion block 110 and/or controller 120. Sensor 121 may be positioned for detecting absence of a pan or pot on cooktop platform 130 of FIG. 5 for a threshold amount of time for automatically turning off radiant heating module 100 to save energy and/or for safety.

Electrical connector 20 may be coupled to controller 120, and controller 120 may be coupled to terminals inside of electrical interface block 110. Electrical connector 20 is configured for coupling to a socket for an electrical resistance heating coil of a conduction heating stovetop for receiving an AC electrical input. Along those lines, radiant heating module 100 may be configured for interchange with electric burner 14, or more particularly an electrical resistance heating coil 15 of conductive heating stovetop 10 may be exchanged for a more energy efficient radiant heating module 100.

Electrical interface block 110 may be coupled to one or more radiant heating coils, such as inner heating element loop 105 and outer heating element loop 106 for example. Thermostat 103 may be coupled to electrical interface block 110 and temperature sensor 111 for providing feedback control of heating by heating inner heating element loop 105 and outer heating element loop 106 for example.

Controller 120 may be coupled to electrical connector 20 for receiving an AC electrical input associated with a conventional electrical resistance heating coil and may be coupled to electrical interface block 110 for providing an AC electrical output to electrical interface block 110 for controlling heating by such one or more radiant heating coils. Electrical interface block 110, as well as thermostat 103, may operate with AC electrical output provided from controller 120. Additionally, controller 120 may be coupled to thermostat 103, including coupling through electrical interface block 110, to receive a temperature signal from thermostat 103 for additional feedback control for providing AC output to electrical interface block 110.

FIG. 5 is the top view depicting an exemplary conventional electric conduction heating stovetop 10 though with a radiant heating module 100 replacing one of the electric burners 14. Radiant heating module 100 includes a cooktop platform 130, which may be supported by housing 101 and/or insert 102. Cooktop platform 130 may be for a single burner and may be a glass-ceramic platform. Optionally, cooktop platform may have formed therein a pattern of channels 131. Radiant heating module 100 may be configured for insertion into drip bowl 12.

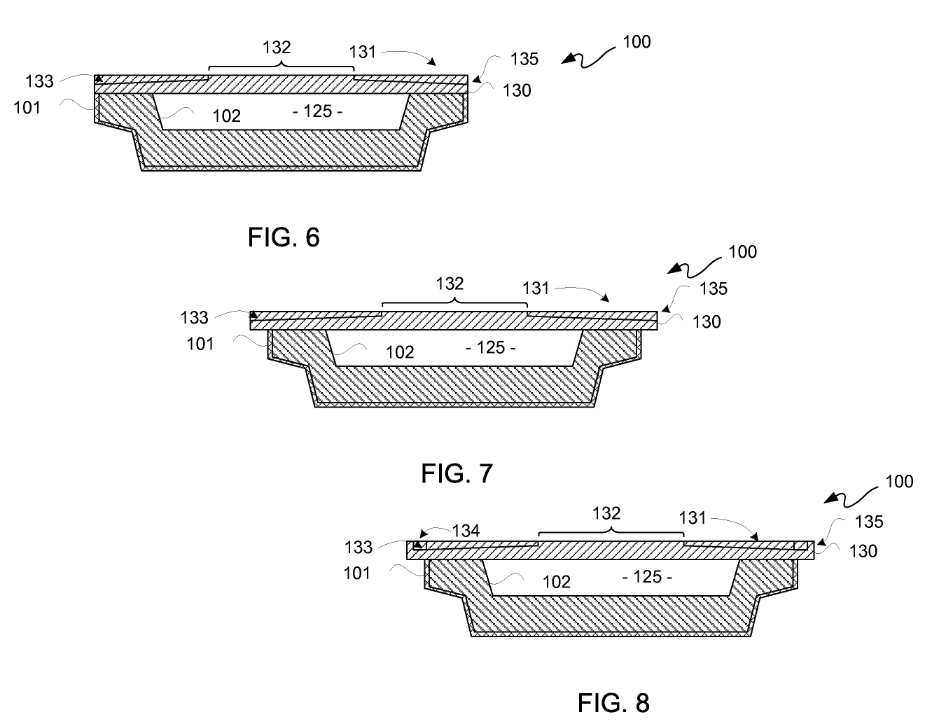

FIG. 6 is a cross-sectional side view depicting an exemplary radiant heating module 100. Channels 131 may be radial channels with a downward slope 133 away from a central region 132 of cooktop platform 130 toward edge 135 of cooktop platform 130. Radiant heating module 100 may be configured for insertion into drip bowl 12, and so ends of channels 131 along edge 135 may allow fluids to drip into drip bowl 12. An interior region 125 may be defined between an inner upper surface of insert 102 and an inner area portion of a lower surface of cooktop platform 130.

FIG. 7 is a cross-sectional side view depicting another exemplary radiant heating module 100. Channels 131 may be radial channels with a downward slope 133 away from a central region 132 of cooktop platform 130 toward edges 135 of cooktop platform 130. Edges 135 may extend beyond housing 101, as cooktop platform 130 may have a larger diameter than housing 101. Downward slope 133 may thus allow fluid to pour out onto stovetop 10 into a spillway, not shown.

FIG. 8 is a cross-sectional side view depicting yet another exemplary radiant heating module 100. Channels 131 may be radial channels 131 with a downward slope 133 away from a central region 132 of cooktop platform 130 toward edges 135 of cooktop platform 130. Edges 135 may extend beyond housing 101, as cooktop platform 130 may have a larger diameter or width than housing 101. Downward slope 133 may thus allow fluid to pour out into an outer perimeter channel 134 formed in cooktop platform 130. Outer perimeter channel 134 may be positioned for communication of fluid from radial channels 131 to outer perimeter channel 134.

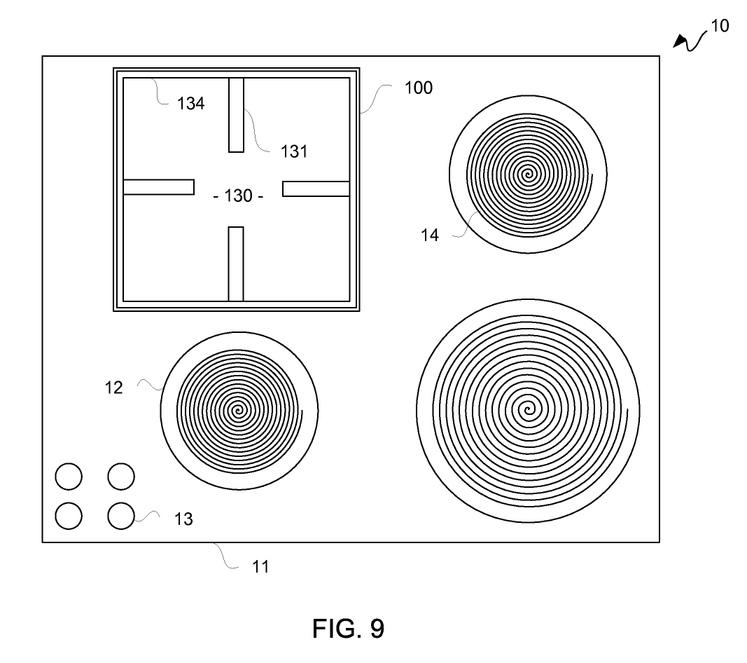

FIG. 9 is a top view depicting an exemplary conventional electric conduction heating stovetop 10 though with a radiant heating module 100 of FIG. 8 replacing one of the electric burners 14. Radiant heating module 100 includes a cooktop platform 130, which may be supported by housing 101 and/or insert 102. Cooktop platform 130 may be for a single burner and may be a glass-ceramic platform. Optionally, cooktop platform 130 may have formed therein a pattern of channels 131 and an outer perimeter channel 134. Radiant heating module 100 may be configured for insertion into an opening in upper platform surface 11 for a drip bowl 12, and such drip bowl 12 may be removed for installation of radiant heating module 100. Even though cooktop platform 130 may have a square or rectangular shape, housing 101 thereunder may have a bowl-like shape for fitting into a drip-bowl cavity defined in conductive heating stovetop 11 for an electrical resistance heating coil 14.

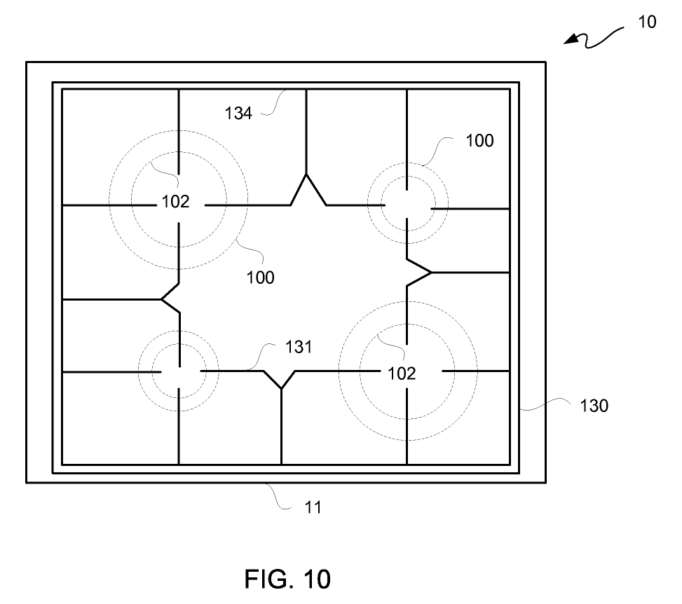

FIG. 10 is a top view depicting an exemplary conventional electric conduction heating stovetop 10 though with radiant heating modules 100 replacing corresponding electric burners 14, as generally indicated by dashed circles, of such conventional electric conduction heating stovetop 10. Radiant heating modules 100 include a cooktop platform 130, which may be supported by housings 101 and/or inserts 102. Cooktop platform 130 in this implementation may be a solid surface cooktop for multiple burners and may be a glass-ceramic platform. Optionally, cooktop platform 130 may have formed therein a pattern of channels 131 and an outer perimeter channel 134. Radiant heating modules 100 may be configured for insertion into corresponding openings in upper platform surface 11 for drip bowls 12, and such drip bowls 12 may be removed for installation of radiant heating modules 100. Even though cooktop platform 130 may have a square or rectangular shape, housings 101 thereunder may each have a bowl-like shape for fitting into each drip-bowl cavity defined in conductive heating stovetop 11 for electrical resistance heating coils 14. Optionally, four separate radiant heating modules 100 may be installed initially without any cooktop platform 130. Cooktop platform 130 may then be a separate piece, namely a single sheet which is separately installed covering such four separate radiant heating modules 100 in this example. After installation of such four separate radiant heating modules 100, such cooktop platform 130 may provide a unitary surface for cooking. In another implementation, four separate cooktop platforms 130 corresponding to four separate radiant heating modules 100 may be configured for interconnection and/or abutment with one another to give the appearance of a solid surface or single sheet cooktop platform 130. In another implementation, radiant heating modules 100 may be installed in corresponding pairs. Even though four radiant heating modules 100 are described fewer or more than four may be used in other implementations. Again, even though radiant heating modules 100 are described, in another implementation induction heating modules, such as described below, may be used instead of radiant heating modules 100.

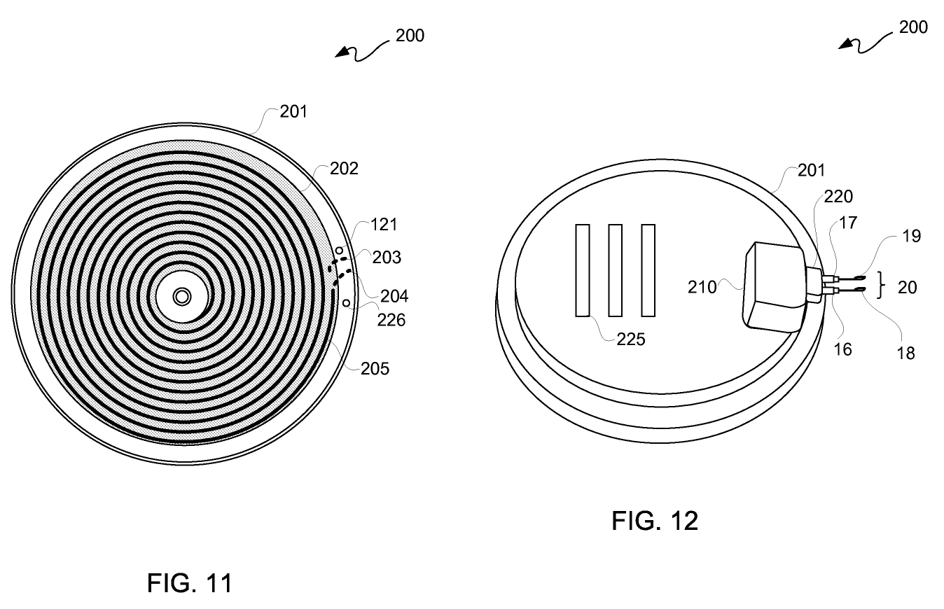

FIG. 11 is a top view depicting an exemplary induction heating module 200 with a top plate, namely a cooktop platform, thereof removed, and FIG. 12 is a bottom projected view depicting induction heating module 200. Induction heating module 200 is further described with simultaneous reference to FIGS. 11 and 12. Induction heating module 200 may be used to replace electric burner 14 instead of above-described radiant heating module 100. Accordingly, cooktop description, which may be the same for modules 100 and 200 is not repeated for purposes of clarity and not limitation.

Induction heating module 200 includes a housing 201, an insert 202, an optional sensor 121, induction element spiral coil 205, a source terminal 204, a return terminal 203, an electrical interface block 210, a controller 220, and an electrical connector 20. Controller 220 may be used to convert an AC input for a conventional electric burner 14 to an AC input for an induction burner for input to an EMI filter of electrical interface block 210. Electrical interface block 210 may include inductors, diodes, and capacitors, as well as other components known for powering induction element spiral coil 205. As many details regarding insert 202, induction element spiral coil 205, source terminal 204, return terminal 203, and electrical interface block 210 are conventional, such components are not described in unnecessary detail for purposes of clarity and not limitation.

Terminals 203 and 204 may be coupled to conversion block 210 through housing 201. Additionally, optional sensor 121 may be in electrical communication with conversion block 210 and/or controller 220. Sensor 121 may be positioned for detecting absence of a pan or pot on cooktop platform 130 for a threshold amount of time for automatically turning off induction heating module 200.

Electrical connector 20 may be coupled to controller 220, and controller 220 may be coupled to terminals inside of electrical interface block 210. Electrical connector 20 is configured for coupling to a socket for an electrical resistance heating coil of a conduction heating stovetop for receiving an AC electrical input. Along those lines, induction heating module 200 may be configured for interchange with electric burner 14, or more particularly an electrical resistance heating coil 15 of conductive heating stovetop 10 may be exchanged for a more energy efficient induction element spiral coil 205 of induction heating module 200.

Electrical interface block 210 may be coupled to an induction heating coil, such as induction element spiral coil (“induction heating coil”) 205 for example. Controller 220 may be coupled to electrical connector 20 for receiving an AC electrical input associated with a conventional electrical resistance heating coil and may be coupled to electrical interface block 210 for providing an AC electrical output to electrical interface block 210 for controlling heating by an induction heating coil 205. Electrical interface block 210 may operate with AC electrical output provided from controller 220.

Controller 220 may be configured for converting an AC electrical input associated with a conventional electrical resistance heating coil to a DC electrical output for induction heating module 200. Electrical interface block 210 may be coupled to receive such a DC electrical output to control heating by induction heating coil 205. A cooktop platform, such as previously described, may be supported by housing 201. Housing 201 may have therein vents 225 for venting heat away from induction heating module 200. Housing 201 may have a bowl-like shape for fitting into a drip-bowl cavity defined in a conventional conductive heating stovetop 11 associated with a conventional electrical resistance heating coil 15. Induction heating module 220 may include a sensor 226 in electrical communication with electrical interface block 210 and/or controller 220 and positioned for detecting magnetic force in a magnetic field passing through a pot or pan on a cooktop platform 130 for magnetic-conductivity and/or electro-conductivity thereof.

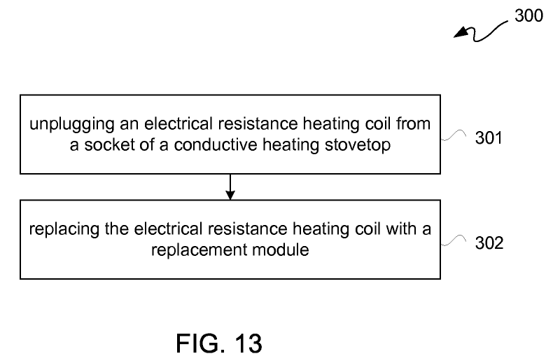

FIG. 13 is a flow diagram depicting an exemplary replacement process 300. At 301, an electrical resistance heating coil 14 may be unplugged from a socket of a conductive eating stovetop 10. Preceding such unplugging is turning off a breaker to such conductive eating stovetop and not having used such electrical resistance heating coil 14 for a sufficient time so as to be removed without injury. At 302, such conventional electrical resistance heating coil 14 may be replaced with a replacement module. Such a replacement module may be either an induction heating module 200 or a radiant heating module 100. Each of induction heating module 200 and radiant heating module 100 has an electrical connector 20 for engagement with such socket. Such replacing includes plugging-in electrical connector 20 of either induction heating module 200 or radiant heating module 100, whichever is used, into such socket. After which, power to conductive eating stovetop 10 may be restored by resetting such breaker.

Though it has been assumed that either induction heating modules 200 or radiant heating modules 100 are used, a combination of one or more induction heating modules 200 and one or more radiant heating modules 100 may be used as replacement modules for a cooktop. Therefore, benefits associated with both types of these modules may be obtained in a single cooktop.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

What is claimed is:

1. An apparatus, comprising:
an induction heating module having an electrical connector;
wherein the electrical connector is configured for coupling to a socket for an electrical resistance heating coil of a conduction heating cooktop for receiving an electrical input; and
wherein the induction heating module is configured for interchange with the electrical resistance heating coil associated with the conductive heating cooktop.

2. The apparatus according to claim 1, wherein the electrical input is an AC electrical input, and wherein the induction heating module comprises:
a housing;
an induction heating coil located in the housing;
a controller for converting the AC electrical input associated with the electrical resistance heating coil to a DC electrical output for the induction heating module;
an electrical interface block coupled to receive the DC electrical output to control heating by the induction heating coil; and
a cooktop platform supported by the housing.

3. The apparatus according to claim 2, wherein the cooktop platform is for a single burner and is a glass-ceramic platform.

4. The apparatus according to claim 2, wherein the cooktop platform has formed therein a pattern of channels.

5. The apparatus according to claim 4, wherein the pattern of channels comprises:
radial channels with a downward slope away from a central region of the cooktop platform; and
an outer perimeter channel of the cooktop platform positioned for communication of fluid from the radial channels to the outer perimeter channel.

6. The apparatus according to claim 2, wherein the induction heating module further comprises a sensor in electrical communication with the electrical interface block and positioned for detecting absence of a pan or pot on the cooktop platform for a threshold amount of time for automatically turning off the induction heating module.

7. The apparatus according to claim 2, wherein the induction heating module further comprises a sensor in electrical communication with the electrical interface block and positioned for detecting magnetic force in a magnetic field passing through a pot or pan on the cooktop platform for magnetic-conductivity and/or electro-conductivity thereof.

8. The apparatus according to claim 2, further comprising:
a plurality of induction heating modules including the induction heating module, wherein the plurality of induction heating modules have electrical connectors;
wherein the electrical connectors are configured for coupling to sockets for electrical resistance heating coils of the conduction heating cooktop for receiving AC electrical inputs;
wherein the plurality of induction heating modules are configured for interchange with the electrical resistance heating coils associated with the conductive heating cooktop; and
a cooktop platform supported by housings of the plurality of induction heating modules, wherein the cooktop platform is a single sheet covering the plurality of induction heating modules.

9. The apparatus according to claim 2, further comprising:
a plurality of induction heating modules including the induction heating module, wherein the plurality of induction heating modules have electrical connectors;
wherein the electrical connectors are configured for coupling to sockets for electrical resistance heating coils of the conduction heating cooktop for receiving AC electrical inputs;
wherein the plurality of induction heating modules are configured for interchange with the electrical resistance heating coils associated with the conductive heating cooktop; and
cooktop platforms of the plurality of induction heating modules supported by housings of the plurality of induction heating modules, wherein the cooktop platforms are coupled to one another to appear as a single sheet covering the plurality of induction heating modules.

10. An apparatus for cooking, comprising:
a radiant heating module having an electrical connector;
wherein the electrical connector is configured for coupling to a socket for an electrical resistance heating coil of a conductive heating cooktop for receiving an electrical input; and
wherein the radiant heating module is configured for interchange with the electrical resistance heating coil associated with the conductive heating cooktop.

11. The apparatus according to claim 10, wherein the electrical input is an AC electrical input, and wherein the radiant heating module comprises:
a housing;
a ceramic bowl located in the housing;
a radiant heating coil located in the ceramic bowl;
an electrical interface coupled to the radiant heating coil;
a thermostat coupled to the housing and to the electrical interface;
a temperature sensor in the ceramic bowl and coupled to the thermostat;
a controller coupled to the electrical connector for receiving the AC electrical input associated with the electrical resistance heating coil for providing an AC electrical output to control heating by the radiant heating coil;
wherein the controller is coupled to provide the AC electrical output to the electrical interface and is coupled to receive a temperature signal from the thermostat for feedback control; and
a cooktop platform supported by the housing.

12. The apparatus according to claim 11, wherein the cooktop platform is for a single burner and is a glass-ceramic platform.

13. The apparatus according to claim 11, wherein the radiant heating module further comprises a sensor in electrical communication with the controller and positioned for detecting absence of a pan or pot on the cooktop platform for a threshold amount of time for automatically turning off the radiant heating module.

14. The apparatus according to claim 11, wherein the cooktop platform has formed therein a pattern of channels, wherein the pattern of channels comprises:
radial channels with a downward slope away from a central region of the cooktop platform; and
an outer perimeter channel of the cooktop platform positioned for communication of fluid from the radial channels to the outer perimeter channel.

15. The apparatus according to claim 11, further comprising:
a plurality of radiant heating modules including the radiant heating module, wherein the plurality of radiant heating modules have electrical connectors;
wherein the electrical connectors are configured for coupling to sockets for electrical resistance heating coils of the conduction heating cooktop for receiving AC electrical inputs;
wherein the plurality of radiant heating modules are configured for interchange with the electrical resistance heating coils associated with the conductive heating cooktop; and
a cooktop platform supported by housings of the plurality of radiant heating modules, wherein the cooktop platform is a single sheet covering the plurality of radiant heating modules.

16. The apparatus according to claim 11, further comprising:
a plurality of radiant heating modules including the radiant heating module, wherein the plurality of radiant heating modules have electrical connectors;
wherein the electrical connectors are configured for coupling to sockets for electrical resistance heating coils of the conduction heating cooktop for receiving AC electrical inputs;
wherein the plurality of radiant heating modules are configured for interchange with the electrical resistance heating coils associated with the conductive heating cooktop; and
cooktop platforms of the plurality of radiant heating modules supported by housings of the plurality of radiant heating modules, wherein the cooktop platforms are coupled to one another to appear as a single sheet covering the plurality of radiant heating modules.

17. A method, comprising:
unplugging an electrical resistance heating coil from a socket of a conductive heating cooktop;
replacing the electrical resistance heating coil with a replacement module;
wherein the replacement module is either an induction heating module or a radiant heating module;
wherein each of the induction heating module and the radiant heating module has an electrical connector for engagement with the socket; and
wherein the replacing includes plugging-in the electrical connector of either the induction heating module or the radiant heating module into the socket.

18. The method according to claim 17, wherein:
each of the induction heating module and the radiant heating module have a cooktop platform having formed therein a pattern of channels; and
the pattern of channels comprises:
radial channels with a downward slope away from a central region of the cooktop platform; and
an outer perimeter channel of the cooktop platform positioned for communication of fluid from the radial channels to the outer perimeter channel.

19. The apparatus according to claim 17, wherein each of the induction heating module and the radiant heating module have a housing having a bowl-like shape for fitting into a drip-bowl cavity defined in the conductive heating cooktop associated with the electrical resistance heating coil.

20. The apparatus according to claim 17, wherein the replacement module comprises a sensor in electrical communication with a controller, wherein the sensor is positioned for detecting absence of a pan or pot on a cooktop platform of the replacement module for a threshold amount of time for automatically turning off the replacement module.
